(19) United States
(12) Patent Application Publication
(10) Pub. No.: US 2012/0097811 A1
(43) Pub. Date: Apr. 26, 2012

(54) Resilient foot

(76) Inventors: Martin P. Burns, Forked River, NJ (US); Stanley Szprengiel, Jackson, NJ (US)

(21) Appl. No.: 12/925,444

(22) Filed: Oct. 21, 2010

(51) Int. Cl. F16M 11/20

(52) U.S. Cl. 248/188.9

(57) ABSTRACT

The resilient foot has a rubber tubular member to provide a resilient support and an insert of solid material within the tubular member to limit the travel of the resilient foot under load. The insert is disposed in a bore of the tubular member and is inwardly spaced a small distance from the support surface of the tubular member to limit the vertical motion.

This invention relates to a resilient foot. More particularly, this invention relates to a resilient foot for a support leg.

As is known, many devices require some resilience in their mounting whether for vibration absorbtion or for maintaining the device level on a mounting surface. In many instances, these devices are provided with a resilient means, such as one or more support feet of elastomeric material, on an undersurface to support the device on the mounting surface in order to absorb vibrations and the like. However, there is a need to limit the total travel to prevent resonance, or “walking” of the device, or damage or permanent deformation to the resilient means.

Accordingly, it is an object of the invention to limit the total travel of a resilient foot for a device.

It is another object of the invention to limit the total travel of a resilient foot at minimal cost and without complicated construction.

Briefly, the invention provides a resilient foot to be mounted on a vertically disposed leg for a piece of equipment in order to damp vibrations between the piece of equipment and a horizontal mounting surface on which the equipment is mounted and which is characterized in being able to limit the total travel of the foot in use.

In accordance with the invention, the resilient foot has a tubular member having a surface for resting on the horizontal mounting surface, a bore that extends from the surface of the foot and being of a predetermined resiliency to be resiliently compressible under a load placed on the leg to absorb vibrations between the leg and the horizontal mounting surface, and an insert or core disposed within the bore and having a terminal end inwardly spaced from the surface of the tubular member and being of a resiliency less than the tubular member to limit the total compression of the tubular member under the load.

In one embodiment, the resilient foot is comprised of a tubular member of elastomeric material, for example of rubber, and in particular a rubber with a Durometer of 50 Shore A while the insert is of solid material, such as of metal, and in particular of brass.

In further accordance with the invention, the insert has a roughened exterior surface, for example, provided by striations or knurling, for frictionally engaging within the bore of the tubular member. In addition, the roughened exterior surface of the insert is spaced from the support surface of the tubular member a distance sufficient to permit vertical movement of the terminal end of the insert into co-planar relation with support surface of the tubular member under vibration loadings. That is to say, this distance is sufficient to allow some vertical motion of the insert before the insert contacts the mounting surface but small enough to limit this motion so as to prevent resonance, or “walking” of the device, or damage or permanent deformation to the resilient foot.

In order to mount the resilient foot on a leg of the device being supported, the insert has an internally threaded bore extending from an end opposite the terminal end and the leg has an externally threaded stud threaded into the bore of the insert. This type of mounting also allows for height adjustments to be made.

These and other objects and advantages of the invention will become more apparent from the following detailed description taken inn conjunction with the accompanying drawings wherein:

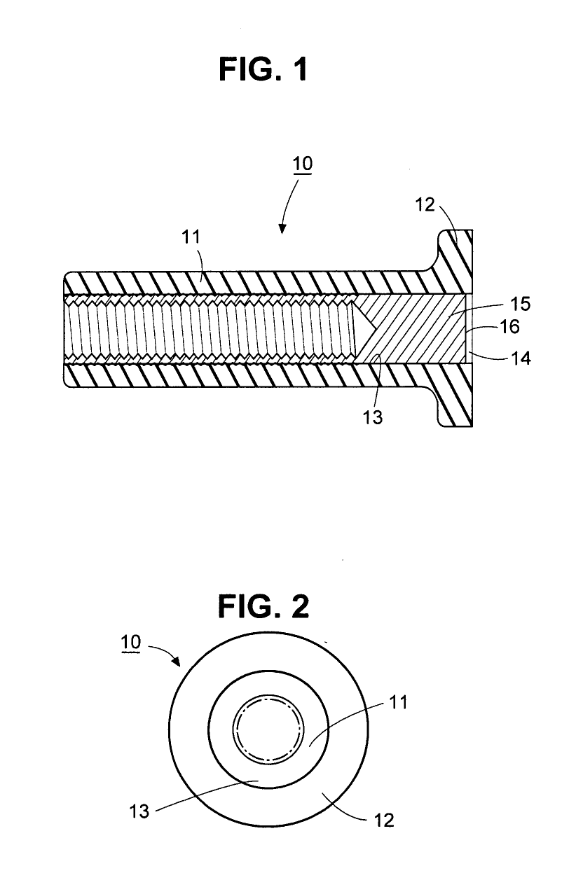

FIG. 1 illustrates a cross-sectional view of a resilient foot constructed in accordance with the invention;

FIG. 2 illustrates a left-hand end view of the resilient foot of FIG. 1;

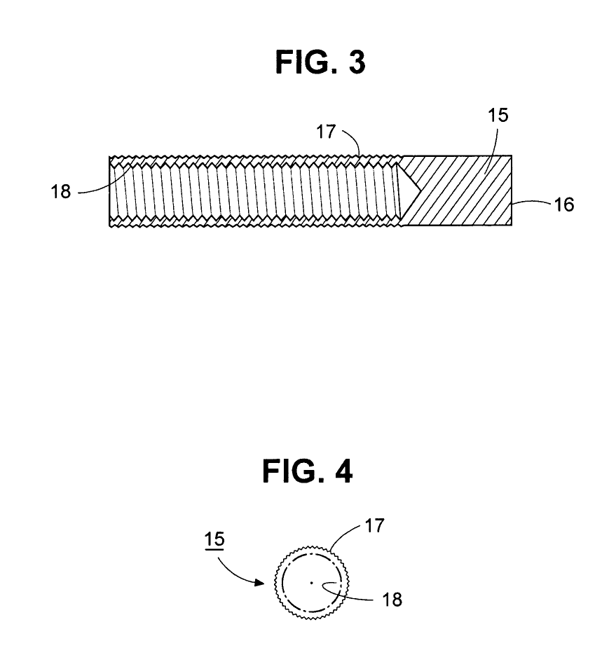

FIG. 3 illustrates a cross-sectional view of the insert of the resilient foot of FIG. 1;

FIG. 4 illustrates a left-hand end view of the insert of FIG. 3; and

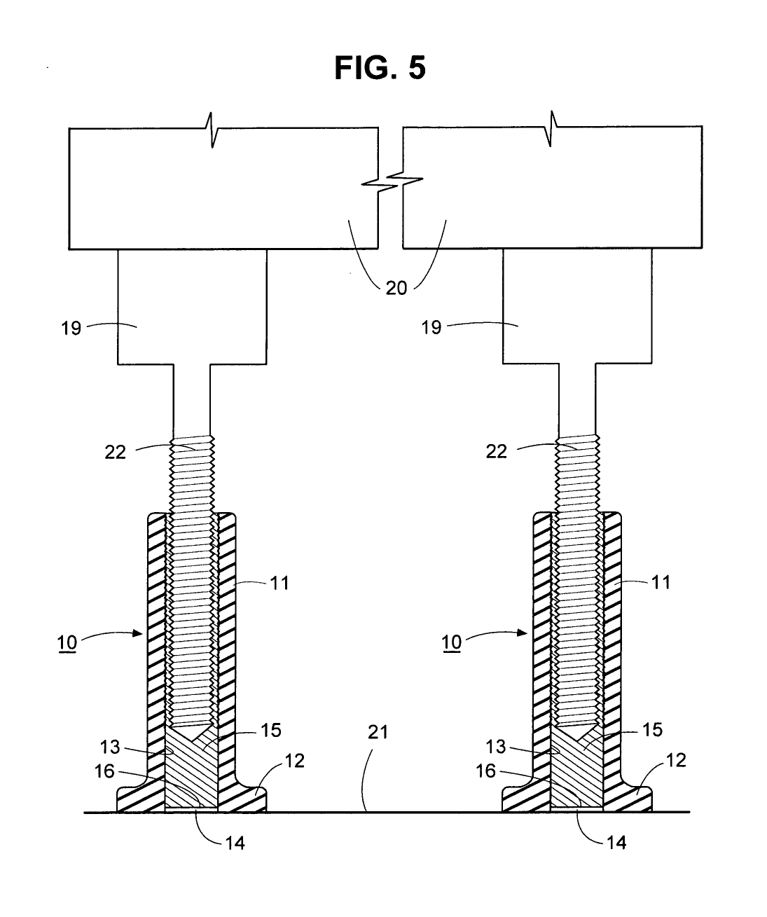

FIG. 5 illustrates a cross-sectional view of the resilient foot of FIG. 1 mounted on a support leg of a device disposed on a horizontal mounting surface.

Referring to FIGS. 1 and 2, the resilient foot 10 includes a tubular member 11 of cylindrical shape with a flange 12 of circular shape at the terminal end and a bore 13 that extends into and through the entire length of the tubular member 11. The tubular member 11 is of elastomeric material, such as rubber, and the flange 12 has a flat support surface 14 at the terminal end of the tubular member 11.

In addition, the resilient foot 10 includes an insert or core 15 of solid material that is disposed within the bore 13 of the tubular member 11. As illustrated, the insert 15 has a terminal end 16 that is inwardly spaced from the support surface 14 of the tubular member 11 a distance to allow the tubular member 11 to compress under a longitudinally applied load before the terminal end 16 of the insert 15 comes into co-planar relation with the support surface 14 of the tubular member 12.

The bore 13 of the tubular member 11 is of cylindrical shape but may be of any other suitable cross-section, such as rectangular, to receive the core 15 therein. In this respect, the tubular member 11 is overmolded on the core 15 so that the shape of the cross-section of the core and the bore 13 of the tubular member 11 may be of any suitable shape.

Referring to FIGS. 3 and 4, the insert 15 has a roughened exterior surface 17, for example, provided by striations or knurling for frictionally engaging within the bore 13 of the tubular member 11 (not shown). As illustrated, the roughened exterior surface 17 extends along a major fractional length of the insert 15 and terminates at a point spaced from the terminal end of the insert 15. As indicated in FIG. 1, the roughened surface 17 is spaced from the support surface 14 of the tubular member 11 by a distance sufficient to permit movement of the support surface 14 of the tubular member 11 into co-planar relation with the terminal end 16 of the insert.

Referring to FIG. 3, the insert 14 has an internally threaded bore 18 extending from an end opposite to the terminal end 16 for purposes as described below.

Referring to FIG. 5, the resilient foot 10 is sized to be mounted on a depending leg 19 of a device 20 that is disposed on a horizontal mounting surface 21. The device 20 may, for example be a refrigerator, deep fryer, toaster, mixer or any table top device.

As illustrated, the device 20 has a plurality of legs 19 for supporting the device 20 on the support surface 21. Each leg 19 is provided with an externally threaded stud 22 that is threaded into the bore 18 of the insert 15 of the resilient foot 10. The threading of the resilient foot 10 onto the threaded stud 22 allows the resilient foot 10 to be height adjusted so as to resiliently support the device 20 on the mounting surface 21.

By way of example, the device 20 may have four legs 19 that support the device 20 on the mounting surface 21. Each leg 19 would have a resilient foot 10 mounted thereon.

When mounted on the mounting surface 21, the device 20 is supported via the legs 19 and resilient feet 10. When the device 20 is stationary, the tubular member 11 of each foot 10 is compressed longitudinally under the weight of the device 20 as applied vertically. However, the terminal end 16 of the insert 15 within each foot 10 remains spaced above the mounting surface 21.

However, should the device 20 be subject to vibration, the tubular member 11 of each resilient foot 10 further compresses and relaxes to absorb, i.e. damp, the vibrations of the device 20 relative to the mounting surface 21. At the same time, the lower portion of the insert 15 is moved vertically relative to the tubular member 11. The spacing of the insert 15 from the mounting surface 21 is sufficient to allow some vertical motion of the insert before the insert 14 contacts the mounting surface 21. This distance is small enough to limit the vertical motion so as to prevent resonance or “walking” of the device 20 on the support surface 21 or damage or permanent deformation to the tubular member 11.

In the illustrated embodiment, the elastomeric member 11 is made of rubber having a Durometer of 50 Shore A and the insert 15 is made of a solid material, such as a metal material, for example being made of brass. Further, the tubular member 11 has a length of 2.57 inches and an outer diameter of 0.72 inches; the flange 12 has a diameter of 1.26 inches and a thickness of 0.220 inches; and the insert 15 has a length of 2.530 inches, a diameter of 0.433 inches and the roughened surface 17 has a length of 1.8 inches. In this example, the terminal end 16 of the insert 15 is spaced a distance of 0.040 inches from the support surface 14 of the tubular member 11. Depending upon the size of the parts of the resilient foot 11, these dimensions may vary.

The roughened surface 17 of the insert 15 is sufficient to permit the insert to be frictionally engaged within the tubular member 11. In this respect, the insert 15 may be placed in a mold and the elastomeric material molded over the insert 15 to form the tubular member 11.

The invention thus provides a resilient foot 10 that has a tubular member 11 of a predetermined resiliency to be resiliently compressible under a load placed on the member 11 in order to absorb vibrations while the insert 15 is of a resiliency less than that of the tubular member 11 in order to limit the total compression of the tubular member 11 under load. In this regard, the insert 15 may be made of a metal material, such as brass. However, other materials may also be used to achieve a purpose of the invention. For example, the insert 15 may be made of a significantly harder elastomeric material, i.e. a plastic, than the tubular member 11 to achieve the results desired.

What is claimed is:

1. A resilient foot comprising
a tubular member of elastomeric material having a support surface at a terminal end thereof and a bore extending into said terminal end; and
an insert of solid material disposed within said bore of said tubular member, said insert having a terminal end inwardly spaced from said support surface of said tubular member.

2. A resilient foot as set forth in claim 1 wherein said insert has a roughened exterior surface for frictionally engaging within said bore of said tubular member.

3. A resilient foot as set forth in claim 2 wherein said roughened exterior surface of said insert is spaced from said support surface of said tubular member a distance to permit movement of said support surface into co-planar relation with said terminal end of said insert.

4. A resilient foot as set forth in claim 3 wherein said insert has a diameter of 0.433 inches and is spaced from said support surface a distance of 0.040 inches.

5. In combination,
a vertically disposed leg for a piece of equipment; and
a resilient foot mounted on said leg for resiliently supporting said leg on a horizontal mounting surface, said foot having a tubular member of elastomeric material having a surface for resting on the horizontal mounting surface and a bore extending from said surface of said foot, and an insert of a resiliency less than said tubular member disposed within said bore and having a terminal end inwardly spaced from said surface of said tubular member.

6. The combination as set forth in claim 5 wherein said insert has a roughened exterior surface for frictionally engaging within said bore of said tubular member.

7. The combination as set forth in claim 6 wherein said roughened exterior surface of said insert is spaced from said surface of said tubular member a distance to permit movement of said surface of said tubular member into co-planar relation with said terminal end of said insert.

8. The combination as set forth in claim 5 wherein said tubular member is resiliently compressible under a load placed on said leg to absorb vibrations between said leg and the horizontal surface and wherein said insert limits the total compression of said tubular member under said load.

9. The combination as set forth in claim 5 wherein said insert has an internally threaded bore extending from an end opposite said terminal end and said leg has an externally threaded stud threaded into said bore of said insert.

10. In combination,
a vertically disposed leg for a piece of equipment; and
a resilient foot mounted on said leg for resiliently supporting said leg on a horizontal surface, said foot having a tubular member having a surface for resting on the horizontal surface, a bore extending from said surface of said foot and being of a predetermined resiliency to be resiliently compressible under a load placed on said leg to absorb vibrations between said leg and the horizontal surface, and an insert disposed within said bore and having a terminal end inwardly spaced from said surface of said tubular member and being of a resiliency less than said tubular member to limit the total compression of said tubular member under said load.

11. The combination as set forth in claim 10 wherein said insert has an internally threaded bore extending from an end opposite said terminal end and said leg has an externally threaded stud threaded into said bore of said insert.

12. The combination as set forth in claim 10 wherein said tubular member is made of rubber and said insert is made of brass.

13. The combination as set forth in claim 12 wherein said tubular member has a Durometer of 50 Shore A.

14. The combination as set forth in claim 13 A wherein said insert has a diameter of 0.433 inches and is spaced from said support surface a distance of 0.040 inches.
